(19) United States
(12) Patent Application Publication
(10) Pub. No.: US 2024/0359346 A1
(43) Pub. Date: Oct. 31, 2024

(54) ATTACHMENT FOR ELECTRIC HAIR CLIPPER

(71) Applicant: D.I.C CORPORATION, Tokyo (JP)

(72) Inventors: Fumiko Endo, Tokyo (JP); Takashige Sadanobu, Tokyo (JP)

(21) Appl. No.: 18/565,106

(22) PCT Filed: May 31, 2021
(86) PCT No.: PCT/JP2021/020750

§ 371 Date: Nov. 29, 2023

(51) Int. Cl. B26B 19/44; B26B 19/22; B26B 19/38

(52) U.S. Cl. CPC B26B 19/44; B26B 19/22; B26B 19/3813

(57) ABSTRACT

An attachment for electric hair clippers is provided that enables hair trimming using thinning scissors to be realized with electric hair clippers and that has a cutting ratio according to the thickness and texture of the hair. The vacuum-drawn electric hair clipper of the embodiment is an attachment attachable to both sides of a clipper blade unit and is characterized in that the attachment comprises an inclined portion on which a blade portion of a clipper blade unit is disposed, and a comb portion having a teeth tip portion at an end of the inclined portion and arranged in a predetermined number in a lateral direction with same teeth gaps, wherein the comb portion has a shape with shallow depth between adjacent teeth and a shape with deep depth between adjacent teeth alternately arranged.

### TECHNICAL FIELD

The present invention relates to an attachment for a vacuum-drawn electric hair clipper and a vacuum-drawn electric hair clipper.

### BACKGROUND ART

In recent years, with the aging of society, the number of people who spend most of their time lying in beds in hospitals, nursing homes, or their own homes is increasing. For those bedridden people, it is often difficult to keep their bodies raised in bed. For some people, it is even difficult to raise their upper bodies slightly.

In general, when haircutting a person lying on their back in bed, a barber or a beautician (hereinafter referred to as “barber”) often has to support the head of the person to be haircut (hereinafter referred to as “client”) to maintain a space between the bed and the client's head while cutting hair. When the client is lying on bed, the position of the back of the client's head relative to the top of the bed may be lifted about 15 to 20 cm at the highest. It is not desirable to lift the client's head any higher considering the increased strain on the client.

In addition, in hospitals or nursing homes, the client may have dementia or mental illnesses. In such cases, barbers use vacuum-drawn electric hair clippers instead of scissors normally used in barbershops, considering the client's safety.

The vacuum-drawn electric hair clipper can be connected to a household vacuum cleaner by installing an attached suction cover to the electric hair clipper. The barber trims the client's hair with the electric hair clipper while running a vacuum cleaner, so that the trimmed hair is collected in the vacuum cleaner. The applicant has already invented vacuum-drawn electric hair clippers shown in Patent Document 1 and Patent Document 2.

When vacuum-drawn electric hair clippers are used to trim hair, usually the vacuum-drawn electric hair clipper is moved from bottom to top (or from top to bottom) to trim hair short. Some clients may prefer, for example, to have their hair trimmed to relatively long length using thinning scissors. However, the vacuum-drawn electric hair clippers were not capable of replicating the same hair trimming as thinning scissors.

### CITATION LIST

### Patent Documents

Patent document 1: JP 6429302
Patent document 2: JP 6688515
Patent document 3: JP 3508124
Patent document 4: JP 6720289

### DISCLOSURE OF THE INVENTION

### Problems to be Solved by the Invention

The problem to be solved by this invention is to provide attachments for vacuum-drawn electric hair clippers and vacuum-drawn electric hair clippers that replicate the same hair trimming as thinning scissors.

### Means for Solving the Problems

The attachment for a vacuum-drawn electric hair clipper of the embodiment is an attachment that is attachable to a vacuum-drawn electric hair clipper that cuts hair suctioned into a space of a suction port formed between a blade portion of a clipper blade unit and one end of a clipper main body by the blade portion comprising a pair of mounting portions slidingly inserted while holding both sides of the clipper blade unit, an attachment body forming a U-shaped recess with the pair of mounting portions, and a plurality of teeth arranged between the pair of mounting portions; wherein, when the attachment is attached to the clipper blade unit. the attachment has spaces between adjacent teeth that face the clipper blade unit and spaces between adjacent teeth that do not face the clipper blade unit.

### Advantageous Effects of the Invention

Using the attachment for the vacuum-drawn electric hair clipper and the vacuum-drawn electric hair clipper in the embodiment, the same hair trimming as thinning scissors with electric hair clippers can be replicated. Also, by selecting an attachment, the cutting ratio during hair trimming can be freely selected according to the thickness and texture of the hair.

### BRIEF DESCRIPTION OF THE DRAWINGS

FIG. 1 shows a side view of the vacuum-drawn electric hair clipper according to an embodiment.

FIG. 2 shows the vacuum-drawn electric hair clipper viewed from the rear side, and the suction hose to be connected to the vacuum-drawn electric hair clipper according to an embodiment.

FIG. 3 shows an expanded perspective view of the area around the clipper blade unit and an end portion of the top housing of the vacuum-drawn electric hair clipper according to an embodiment.

FIG. 4 shows an expanded perspective view of the area around the clipper blade unit and the end portion of the top housing of the vacuum-drawn electric hair clipper according to an embodiment.

FIG. 5 shows the vacuum-drawn electric hair clipper according to an embodiment viewed from the bottom housing side with the clipper blade unit removed.

FIG. 6 shows a perspective view of the vacuum-drawn electric hair clipper of FIG. 1 with the top housing removed and viewed from the upper surface of the middle housing.

FIG. 7 shows a perspective view of the vacuum-drawn electric hair clipper of FIG. 6 with the middle housing further removed and viewed from the upper surface of the bottom housing.

FIG. 8 shows the wiring of the circuit board behind the motor in the bottom housing of the vacuum-drawn electric hair clipper according to an embodiment.

FIG. 9 shows an attachment with a thinning scissors function attached to the clipper blade unit of a vacuum-drawn electric hair clipper according to an embodiment.

FIG. 10(a) is a bottom view of the attachment.

FIG. 10(b) shows a side view of the attachment.

FIG. 10(c) shows the attachment seen from the front side (the clipper blade unit's side) with the dashed line indicating the clipper blade unit.

FIG. 10(d) shows a side view of the attachment with the dashed lines indicating the clipper blade unit.

FIG. 11 shows the shape of a first attachment that provides a 50% cutting ratio.

FIG. 12 shows the shape of a second attachment that provides a 26% cutting ratio.

FIG. 13 shows the shape of a third attachment that provides a 36% cutting ratio.

FIG. 14 shows the shape of a fourth attachment that provides a 67% cutting ratio.

### BEST MODE FOR CARRYING OUT THE INVENTION

The details of attachments in some embodiments are described with reference to the attached drawings. For convenience of explanation, embodiments of a vacuum-drawn electric hair clipper and a vacuum-drawn electric hair clipper apparatus to which the attachment is attached will be described first. Then the attachments will be described. In the drawings, the same reference numerals are used for the same components or members. Some dimensional proportions in the drawings may be exaggerated for the convenience of explanation and may differ from the actual proportions.

### The Vacuum-Drawn Electric Hair Clipper and Vacuum-Drawn Electric Hair Clipper Apparatus

FIG. 1 is a side view of the overall configuration of the vacuum-drawn electric hair clipper and vacuum-drawn electric hair clipper apparatus according to an embodiment. The vacuum-drawn electric hair clipper 100 is a handy device that can be held with one hand to cut and trim the client's hair. As shown in FIG. 1, the clipper main body of the vacuum-drawn electric hair clipper 100 comprises a top housing (first housing) 110, a middle housing 120, and a bottom housing (second housing) 130. The top housing 110, the middle housing 120, and the bottom housing 130 are made of plastic materials. The clipper main body is configured into a single unit with the middle housing 120 mounted on top of the bottom housing 130 and the top housing 110 mounted on top of the middle housing 120. A clipper blade unit 140 is detachably disposed at an end of the bottom housing 130. A space 150 is defined between the blade portion 140a of the clipper blade unit 140 and an end portion 110a of the top housing 110. The space 150 is a suction port for the hair.

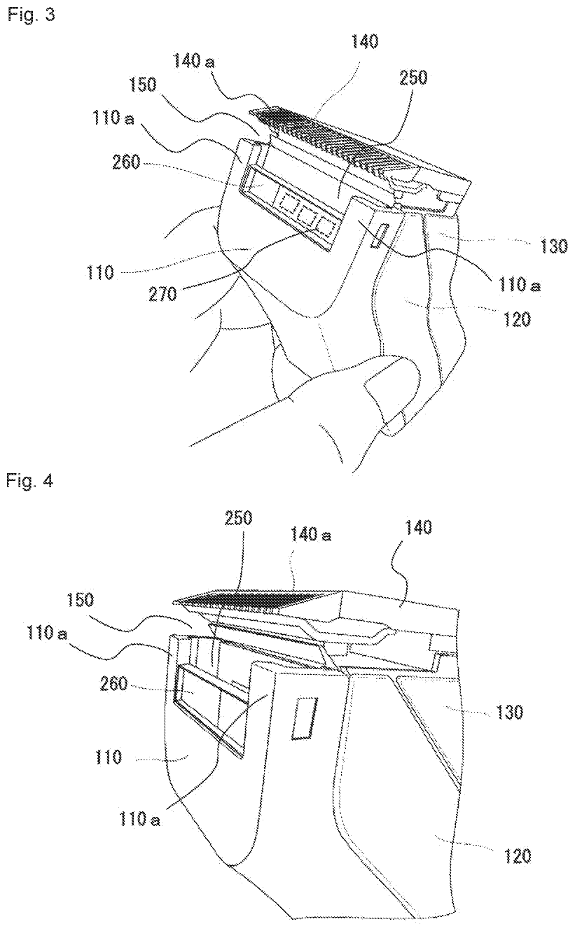

When viewed from the side shown in FIG. 1, the suction gap h between the blade portion 140a and the end portion 110a defining the space 150 is substantially equal to the length of the blade portion 140a in the depth direction R. The depth of the space 150 is longer than the blade portion 140a of the clipper blade unit 140 and is the same as the length of the shorter side of the end portion 110a of the top housing 110. As shown in FIGS. 3 and 4, the width of the space 150 is the same as the length of the longer side of the end portion 110a of the top housing 110 which is the same as the blade width of the blade portion 140a.

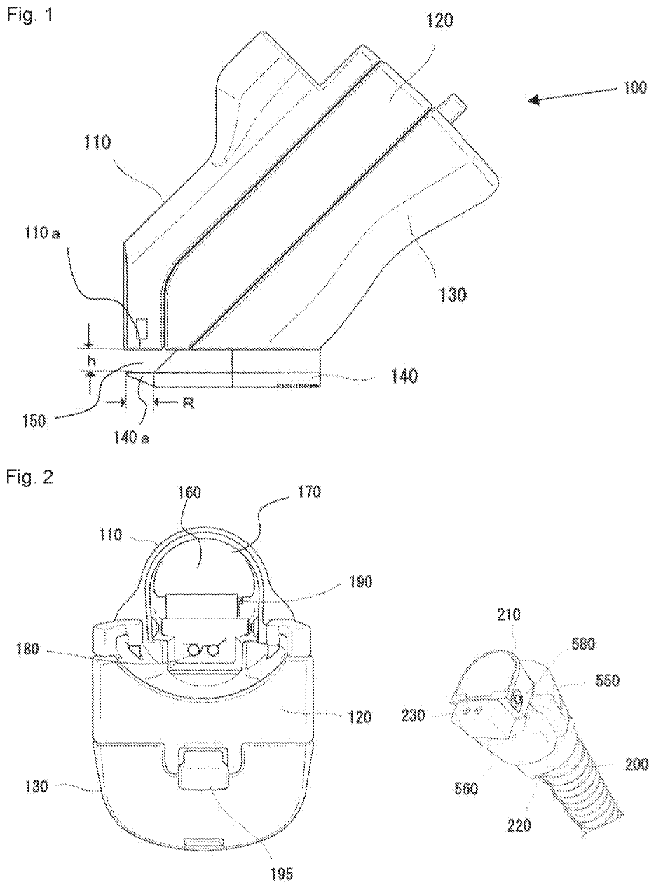

As shown in FIGS. 3 and 4, the end portion 110a of the top housing 110 is a suction port for the hair clipped through the space 150. During haircutting, the client's hair is suctioned from the space 150, and the suctioned hair is cut by the blade portion 140a of the clipper blade unit 140. The cut hair is suctioned into the suction hose 200 described below after going through the suction passage 160 (see FIG. 2) defined between the top housing 110 and the middle housing 120. Therefore, with the vacuum-drawn electric hair clipper 100, the clipped hair will not be scattered in the vicinity and will be suctioned into the vacuum cleaner (not shown) via the suction hose 200.

The blade portion 140a of the clipper blade unit 140 comprises a comb-like movable blade and a comb-like stationary blade (both not shown) stacked on top of each other. The hair suctioned into the end portion 110a of the top housing 110 via the space 150 is held by the stationary blade. The movable blade moves in a horizontal reciprocating motion sliding along the stationary blade. As a result, the hair is cut in a scissors-like action between the edges of the movable blade and the stationary blade.

FIG. 2 shows the vacuum-drawn electric hair clipper 100 and a suction hose connected to the same. In FIG. 2, the vacuum-drawn electric hair clipper 100 is viewed from the rear side. A suction passage 160 that communicates with the space 150 shown in FIG. 1 is defined between the top housing 110 and the middle housing 120. At an end of the suction passage 160 is a connection opening 170. A pair of power supply terminals (power supply port) 180 is disposed inside the connection opening 170 of the suction passage 160. An inclined portion 190 is provided forward (opposite direction of the suction direction) of the power supply terminals 180 inside the connection opening 170. The inclined portion 190 functions to make the clipped hair suctioned toward the upper wall of the top housing 110 so that the hair is not entangled with the power supply terminals 180.

On the right half of FIG. 2 is shown a suction hose 200 that is connected to the connection opening 170. One end of the suction hose 200 is connected to a vacuum cleaner (not shown), and the other end is provided with a hose cover 210. A power supply connector 230 is provided, alongside the hose cover 210, to the suction hose 200 to which an external power supply cord 220 is connected.

The hose cover 210, which is provided at the other end of the suction hose 200, is grasped by a first hose connection cover 550 and a second hose connection cover 560 facing it so that the hose cover 210 is not detached from the suction hose 200.

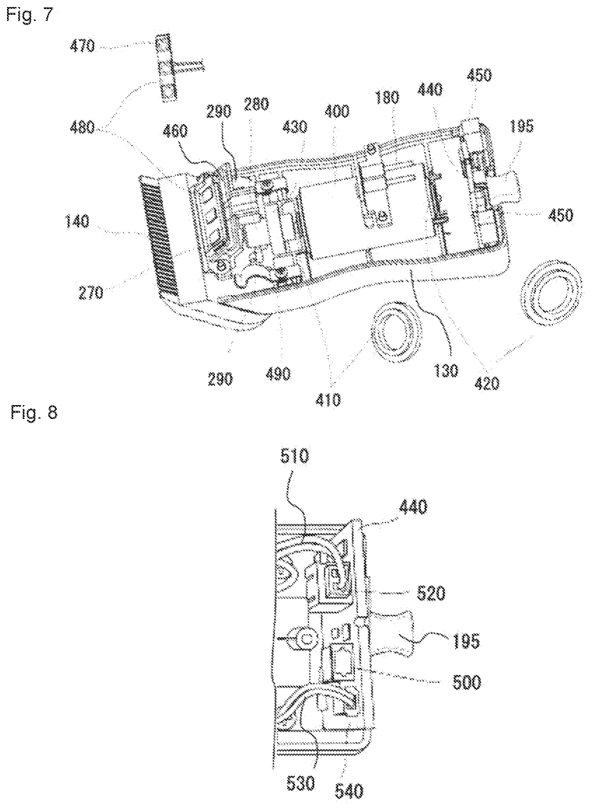

The hose cover 210 and power supply connector 230 of the suction hose 200 are inserted into the connection opening 170, and connected together by the plungers 580. The power supply connector 230 is connected to the pair of power supply terminals 180 when inserted into the connection opening 170. The vacuum-drawn electric hair clipper 100 of the embodiment does not have a built-in power supply unit. Therefore, the external power supply cord 220 is connected to a circuit board 440 (see FIG. 7), described later, via the power supply connector 230 and the pair of power supply terminals 180. Thus, the vacuum-drawn electric hair clipper 100 does not have a built-in power supply unit and is compact in shape.

The configuration for supplying power may be changed as needed for convenience of design. The power supply cord 220 may be routed inside the suction hose 200, for example, along a wire inside the hose, instead of being external to the suction hose 200. It may be configured so that the power supply connector (female pins) is disposed inside the connection opening 170 and the pair of power supply terminals (male pins) are disposed on the suction hose 200.

A power switch 195 is disposed at the back end of the vacuum-drawn electric hair clipper 100. The power switch 195 is operated by a user (e.g., a barber). The power switch 195 controls the ON/OFF of the motor 400 and the ON/OFF of the LED lighting unit 460 as described below. The user may perform the ON/OFF operations with a finger, for example an index finger, of the hand holding the clipper's main body. The power switch 195 may be a slide switch, for example.

FIGS. 3 and 4 show enlarged perspective views of the clipper blade unit 140 of the vacuum-drawn electric hair clipper 100 and the area around the end portion 110a of the top housing 110. As shown in the figures, a substantially U-like shaped inlet opening 250 is defined at the end portion 110a of the top housing 110. Furthermore, a lens cover 260 is disposed on the inlet opening 250 at a position separated away from the blade portion 140a. An LED cover 270 described later is disposed on the middle housing 120 at a position facing the lens cover 260. Light from the LEDs 470, which are disposed under the LED cover 270 (see FIG. 7), passes through the LED cover 270 and the lens cover 260 and illuminates the vicinity of the blade portion 140a. Thus, the area around the blade portion 140a may be illuminated brightly during hair clipping work, so the hair can be clipped under close observation of the condition of the overgrown hair.

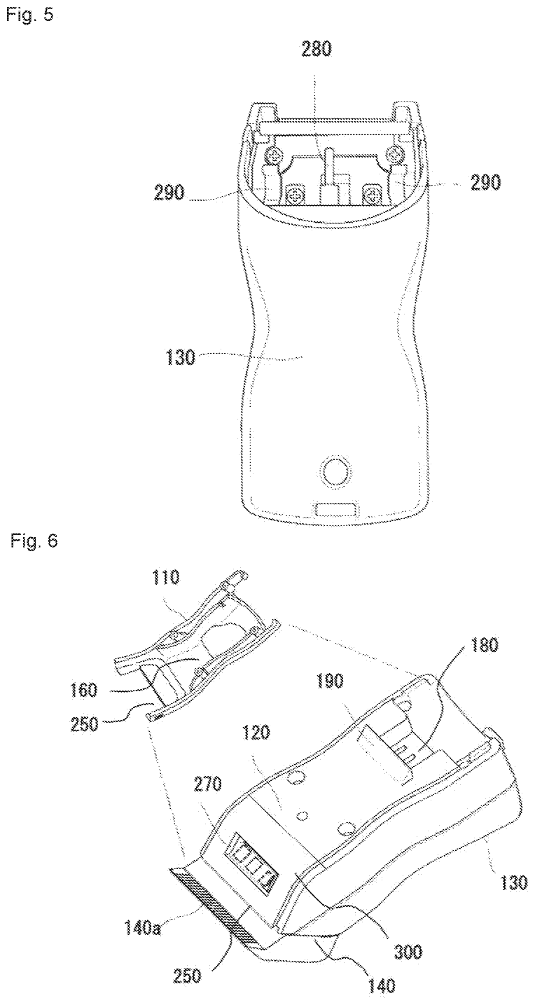

FIG. 5 shows a front view of the vacuum-drawn electric hair clipper 100 seen from the bottom housing 130 side with the clipper blade unit 140 removed. An eccentric shaft 280 is provided at a position that is visible when the clipper blade unit 140 is removed. The eccentric shaft 280 is connected to the rotation shaft of the motor 400 which is described later. The eccentric shaft 280 is not on the axis of rotation of the motor 400, meaning that it is in a displaced (eccentric) axial position. This means that the rotational motion of the eccentric shaft 280 will have a travel width. The travel width is converted into a horizontal reciprocating motion of the movable blade of the clipper blade unit 140 to which it is transmitted. As a result, the movable blade of the blade portion 140a moves from side to side at high speed, resulting in the cutting of hair. Two leaf springs 290 are provided on both sides of the eccentric shaft 280. The leaf springs 290 can reduce the vibration of the clipper blade unit 140. As shown in FIG. 5, the clipper's main body has a narrow portion in the center, making it easy to hold in one hand.

FIG. 6 shows a perspective view of the upper surface of the middle housing 120 with the top housing 110 removed from the vacuum-drawn electric hair clipper 100 of FIG. 1. As shown in FIG. 6, the LED cover 270 shown in FIG. 3 is disposed at the inclined surface 300 of the middle housing 120 on the clipper blade unit 140 side. The inclined portion 190 and the pair of power supply terminals 180 shown in FIG. 2 are arranged in such a way that they are exposed from the upper surface of the middle housing 120. As shown in FIG. 6, the width of the suction passage 160 on the inner surface of the top housing 110 is formed to narrow in the suction direction from the inlet opening 250. This allows the clipped hair to be sucked into the suction cord 200 via the suction passage 160 without scattering.

FIG. 7 shows the top of the bottom housing 130 (perspective view) when the middle housing 120 is further removed from the vacuum-drawn electric hair clipper 100 of FIG. 6. A motor 400 is disposed in the center of the bottom housing 130. The flat portions of the motor 400 on both sides (left and right in the figure) are provided with a first buffer member (made of rubber) 410 and a second buffer member (made of rubber) 420. The motor 400 is housed within the installation ribs of the bottom housing 130. The first and second buffer members 410, 420 may absorb vibrations caused by the rotation of the motor 400 and suppress noise. The eccentric shaft 280 of the motor 400 is supported by a ball bearing 430. The ball bearing 430 is housed within the installation ribs of the bottom housing 130. The ball bearing 430 allows for smooth guiding of the rotation of the eccentric shaft 280.

At the rear end of the bottom housing 130, a circuit board 440 is disposed between the motor 400 and the power switch 195. Three connectors are disposed on the circuit board 440. They are a first connector connected to the power supply terminals 180, a second connector connected to the motor 400, and a third connector connected to an LED board 480. Sponge tapes 450 are disposed on both sides of the circuit board 440. The sponge tapes 450 function as buffer members between the bottom housing 130 and the middle housing 120 when they are connected.

An LED lighting unit 460 is disposed on the clipper blade unit 140 side of the bottom housing 130. The LED lighting unit 460 comprises an LED board 480 on which LEDs 470 are mounted and an LED cover 270 that covers the LEDs 470. The LED board 480 is fixed to the bottom housing 130 with screws. The two leaf springs 290 shown in FIG. 7 are each fixed to the bottom housing 130 with screws 490.

FIG. 8 is a drawing (viewed from the bottom of the bottom housing 130) showing the wiring of the circuit board 440 located behind the motor 400 in the bottom housing 130. Connected to the circuit board 440 are a power connector (first connector) 500 that is connected to the power supply terminals 180, a motor connector (second connector) 520 that is connected to the motor 400 via a wire 510, and an LED connector (third connector) 540 that is connected to the LED board 480 via a wire 530.

When using the vacuum-drawn electric hair clipper with the above configuration for hair trimming, the hair can be trimmed short by moving the vacuum-drawn electric hair clipper 100 from bottom to top or top to bottom with the blade portion 140a oriented toward the hair.

Such an embodiment has a compact structure without a built-in power supply unit and can cut hair drawn into a space defined in the body. A vacuum-drawn electric hair clipper and a vacuum-drawn electric hair clipper apparatus may be provided which have new functions such as a vacuuming function, a noise suppression function, and an illumination function.

### The Attachments

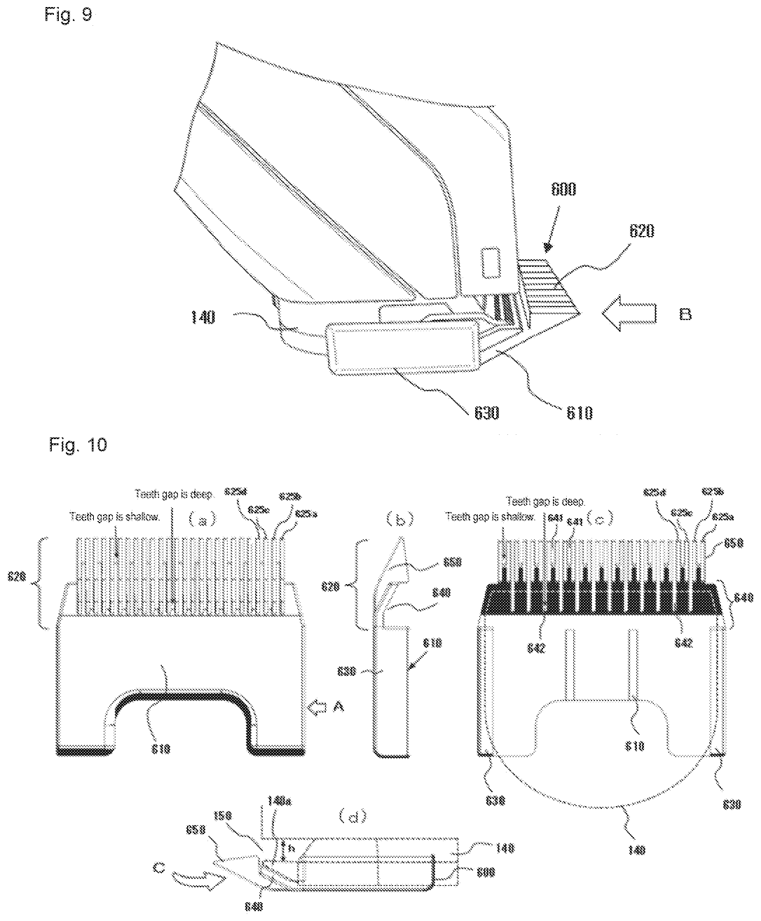

FIG. 9 shows an electric hair clipper with an attachment that replicates the same hair trimming as thinning scissors. The attachment 600 can be attached to and detached from the clipper blade unit 140. When the attachment 600 is attached to the clipper blade unit 140, it is connected by slidingly inserted from the direction of the arrow B while holding at both sides of the clipper blade unit 140. The attachment 600 includes an attachment body portion 610, a comb portion 620, and mounting portions 630, and is integrally molded. The mounting portions 630 are provided on both sides of the attachment 600, are U-shaped, and are slidingly inserted while holding both sides of the clipper blade unit 140.

FIG. 10(a) is a bottom view of the attachment 600 when the attachment is attached as in FIG. 9. As shown in FIG. 10(a), the attachment body portion 610 has an arch-like recess and has a width sufficient to cover the clipper blade unit 140. A comb portion 620 is provided at the end opposite the arch-like recess on the attachment body portion 610. The comb portion 620 comprises a plurality of teeth 625 (625a, 625b, 625c, 625d, . . . ). Among the teeth 625, for example, the teeth 625a and 625b at the right end form a pair. The teeth gap between the teeth 625a and 625b is shallow. The teeth gap between the teeth 625c and 625d is shallow as well. On the other hand, the teeth gap between the teeth 625b and 625c is deep. As described below, shallow and deep teeth gaps are formed alternately. This allows for the same trimming as thinning scissors.

FIG. 10(b) is a side view of the attachment 600 seen from the direction of the arrow A in FIG. 10(a). As shown in FIG. 10(b), the comb portion 620 includes an inclined portion 640 and a teeth tip portion 650. The inclined portion 640 is connected to the attachment body portion 610. The side of the tip of the comb portion 620 is a triangular teeth tip portion 650. The side surface of the inclined portion 640 is formed in a shape having an obtuse angle, which prevents the clipper blade unit 140 from contacting the attachment 600 when the attachment 600 is attached.

FIG. 10(c) is a top view of the attachment 600. As shown in the figure, the deep teeth gap 642 between the teeth 625b and 625c has a space even in the inclined portion 640. That is, the deep teeth gaps 642 are facing the blade portion 140a as shown in FIG. 10 (d). Hence, the hair that enter the deep teeth gaps 642 is configured to reach the blade portion 140a.

FIG. 10(d) shows a side view of the attachment 600 attached to the clipper blade unit 140. In the figure, the clipper blade unit 140 is shown with dashed lines. The attachment 600 is attached to the clipper blade unit 140 in the direction of the arrow B in FIG. 9.

As shown in FIG. 10(d), when the attachment 600 is attached to the clipper blade unit 140, the attachment 600 is inserted up to the position where the inclined portion 640 of the attachment 600 faces the blade portion 140a of the clipper blade unit 140 and stops just before the clipper blade unit 140. In this position, the clipper blade unit 140 and the inclined portion 640 are not in contact. As shown in FIG. 10(c), a portion of the deep teeth gaps 642 (the attachment body portion 610 side) faces the blade portion 140a of the clipper blade unit 140. On the other hand, the shallow teeth gaps 641 do not face the blade portion 140a of the clipper blade unit 140.

When the attachment 600 described above is attached to the clipper blade unit 140, in the case of shallow teeth gaps 641, the hair is stopped by the teeth gaps, making it difficult for the hair to reach the clipper blade unit 140. In the deep teeth gaps 642, hairs entering the deep teeth gaps 642 have a high probability of reaching the blade portion 140a and being cut as in the case where the attachment 600 is not present.

When cutting hair, a short-cut hair style can be created by repeatedly inserting the hair in the area to be cut into the teeth tip portion 650 and moving the clipper main body in the direction of the haircut. Adjustment of the depth at which the teeth tip portion 650 is inserted into the hair at the point where the hair is to be cut is at the discretion of the barber.

When the attachment 600 is attached to a vacuum-drawn electric hair clipper and the hair is being trimmed, if the hair is caught in the deep teeth gaps 642 formed with predetermined gaps between the teeth 625 of the comb portion 620, it is suctioned by the clipper main body toward the space 150. Then the hair is cut by the blade portion 140a of the clipper blade unit 140. On the other hand, if the hair is caught in the shallow teeth gaps 641 of the teeth 625 of the comb portion 620, the hair has a low probability of reaching the space 150 and being suctioned into the space 150. Therefore, the hair caught in the shallow teeth gaps 641 of the teeth 625 is less likely to be cut. As a result, the function of the thinning scissors can be replicated by handling the attachment 600. Attachment 600 is available in several shapes as shown below to cater to different thickness and texture of the clients' hair.

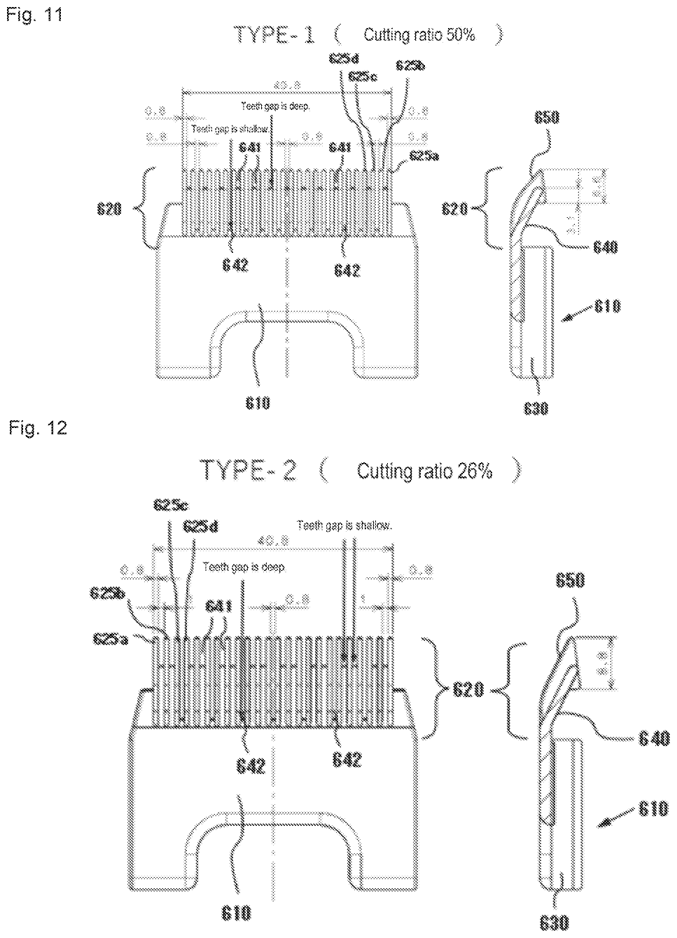

FIG. 11 shows the first attachment TYPE-1 with a cutting ratio of 50%.

The dimensions of TYPE-1 are as follows: width of the comb portion 620: 40.8 mm; thickness of each of the teeth 625: 0.8 mm; gap between adjacent teeth 625: 0.8 mm; width of the tip of the teeth tip portion 650: 6.6 mm; and width from lowest surface of the teeth tip portion 650 to the tip of the inclined portion 640: 3.1 mm.

In TYPE-1, the gaps between adjacent teeth 625 are all identical (teeth gap: 0.8 mm). The space between adjacent teeth 625 has a shape in which shallow and deep teeth gaps 641 and 642 are arranged alternately. The gaps between adjacent teeth 625 may be appropriately set between 0.8 mm and 1.5 mm in order to cater to different thickness and texture of the clients' hair. The width of the tip of the teeth tip portion 650 may be designed in the range between 6.6 mm and 11.5 mm.

FIG. 12 shows the second attachment TYPE-2 with a cutting ratio of 26%.

The dimensions of TYPE-2 are as follows: width of the comb portion 620: 40.8 mm; thickness of each of the teeth 625: 0.8 mm; gap between adjacent teeth 625: 0.8 mm and 1.0 mm; and width of the tip of the teeth tip portion 650: 8.8 mm. In Type-2, as indicated in FIG. 12, the three teeth from the left end 625a, 625b, and 625c are treated as a group. The gaps between the teeth 625a and 625b, and between the teeth 625b and 625c are 1 mm, and the spaces of this area are shallow teeth gaps 641. The gaps between the teeth 625c and 625d are 0.8 mm, and the spaces of this area are deep teeth gaps 642.

TYPE-2 has different gaps between adjacent teeth 625 (gap: 0.8 mm and 1.0 mm), and a plurality of teeth 625 arranged laterally. Furthermore, it has a shape in which spaces between adjacent teeth 625 which are two shallow teeth gaps 641 and spaces between adjacent teeth 625 which are one deep teeth gap 642 are alternately arranged. That is, it has a shape in which a configuration of two shallow teeth gaps 641 and a configuration one deep teeth gap 642 are alternately arranged.

It is preferable to optimally design the gap between each of the 625 teeth in the range of 0.7 mm to 0.9 mm, and the width of the tip of the teeth tip portion 650 in the range of 8.7 mm to 9.0 mm in order to cater to different thickness and texture of the clients' hair.

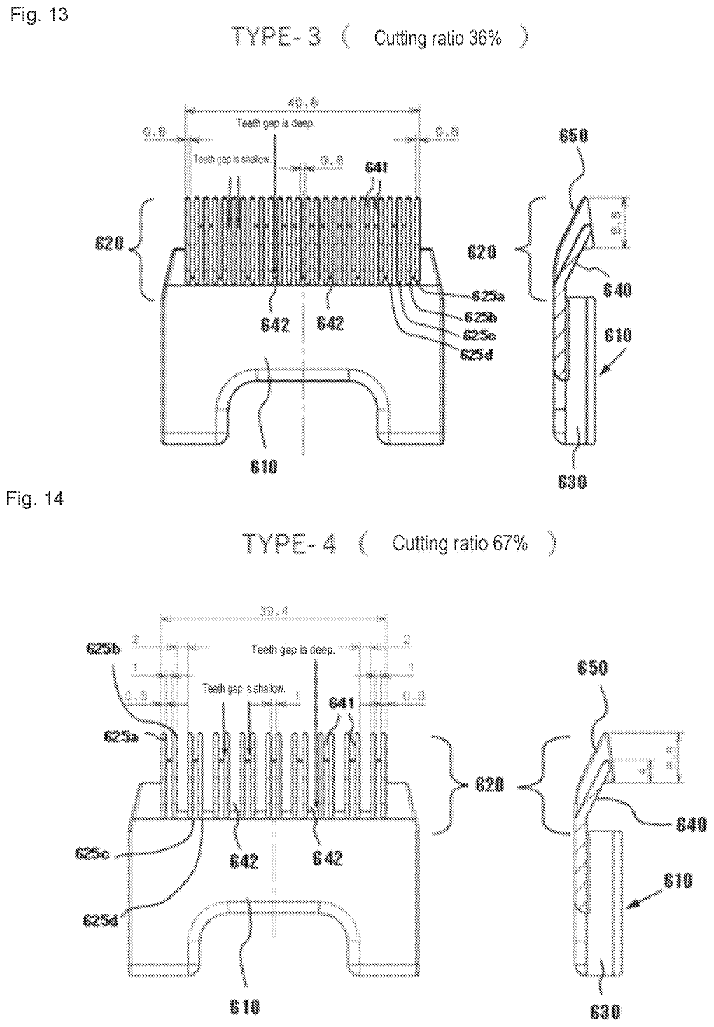

FIG. 13 shows the second attachment TYPE-3 with a cutting ratio of 36%.

The dimensions of TYPE-3 are as follows: width of the comb portion 620: 40.8 mm; thickness of each of the teeth 625: 0.8 mm; gap between adjacent teeth 625: 0.8 mm; and width of the tip of the teeth tip portion 650: 0.8 mm.

In TYPE-3, the gaps between adjacent teeth 625 are identical (teeth gap: 0.8 mm). In the same figure, the gap between the teeth 625a and 625b aligned from the right end is a deep teeth gap 642. The spaces between the teeth 625b and 625c, and between the teeth 625c and 625d are shallow teeth gaps 641. That is, TYPE-3 has a configuration of one deep teeth gap 642 followed by two shallow teeth gaps 641, which are formed alternately. In other words, TYPE-3 has a shape in which a configuration of two shallow teeth gaps and a configuration of one deep teeth gap 642 are alternately arranged.

In the hair trimming with Type-2 or -3 used, when hair is caught in the deep teeth gaps 642 of the comb portion 620, as the hair is suctioned toward the space 150 shown in FIG. 1, the hair is cut by the blade portion 140a of the clipper blade unit 140. On the other hand, when the hair is caught in the shallow teeth gaps 641 of the comb portion 620, the hair has a low probability of being suctioned into the space 150. Therefore, the hair caught in the shallow teeth gaps 641 is less likely to be cut. As a result, the function of the thinning scissors can be replicated by handling the attachment 600.

FIG. 14 shows the fourth attachment TYPE-4 with a cutting ratio of 67%.

The dimensions of TYPE-4 are as follows: width of the comb portion 620: 39.4 mm; thickness of each of the teeth 625: 0.8 mm; gap between adjacent teeth 625: 1.0 mm and 2.0 mm; and width of the tip of the teeth tip portion 650: 8.8 mm; and width from lowest surface of the teeth tip portion 650 to the tip of the inclined portion 640: 4 mm.

In TYPE-4, the gap between teeth 625a and 625b is 1.0 mm, and the gap between teeth 625b and 625c is 2.0 mm, which are arranged alternately. If the gap between adjacent teeth 625 is 1.0 mm, the space is a shallow teeth gap 641. If the gap between adjacent teeth 625 is 2.0 mm, the space is a deep teeth gap 642. Because this TYPE-4 is shaped to have more deep teeth gaps 642 than TYPES 1 through 3, more hair reaches the space 150 of the clipper main body, resulting in a higher cutting ratio. The gap between the teeth 625 for the shallow teeth gap 641 may be appropriately selected from 0.8 to 1.0 mm, and the gap between the teeth 625 for the deep teeth gap 642 may be appropriately selected from 1.2 to 2.0 mm, in order to cater to different thickness and texture of the clients' hair. The width of the tip of the teeth tip portion 650 may be appropriately selected from 8.8 mm to 11.5 mm.

As described above, when the attachment of the embodiment is attached to a vacuum-drawn electric hair clipper, the user can replicate the same hair trimming with the vacuum-drawn electric hair clipper as with the thinning scissors by the user's hair trimming operation. That is, when the attachment 600 is attached to a vacuum-drawn electric hair clipper for hair trimming, the hair caught in the spaces between adjacent teeth 625 of deep teeth gaps 642 has a high probability of being suctioned toward the space 150 shown in FIG. 1. Therefore, the hair is likely to be cut by the blade portion 140a of the clipper blade unit 140. On the other hand, the hair caught in the spaces between adjacent teeth 625 of shallow teeth gaps 641 has a low probability of being suctioned by the space 150. Therefore, the hair in the shallow teeth gaps 641 is less likely to be cut. As a result, the function of the thinning scissors can be replicated by handling the attachment 600. Also, by selecting an attachment 600, the cutting ratio during hair trimming can be freely selected according to the thickness and texture of the hair.

The attachment of the vacuum-drawn electric hair clipper of the embodiment is an attachment 600 that can be attached to both sides of the clipper blade unit 140, and the focus is on the shape of the attachment facing the clipper blade unit 140 in order to control the ratio of hair that reaches the clipper blade unit 140. In other words, a plurality of teeth 625 are provided on attachment 600, and spaces are defined between adjacent teeth 625 (e.g., teeth 625a and 625b) for hair to pass through. The various attachments 600 are provided in such a way that the size and proportion of the aforementioned spaces is varied so that the hair reaches the blade portion 140a of the clipper blade unit 140 through the attachment 600 and the amount of hair suctioned is different.

A portion of a first space (deep teeth gap) formed by adjacent teeth 625 when the attachment 600 is mounted on the clipper blade unit 140 is shaped so that it faces the blade portion 140a. On the other hand, a second space (shallow gap) formed by adjacent teeth 625 is shaped so that it does not face the blade portion 140a. Hair that enters the first space (deep teeth gap) provided at the position facing the clipper blade unit 140 is suctioned into the body and cut by the blade portion 140a when it reaches the space 150 of the clipper main body via the blade portion 140a. On the other hand, hair that enters the space (shallow teeth gap) provided at the position not facing the clipper blade unit 140 does not reach the blade portion 140a, is not suctioned into the body, and is not cut. As a result, the function of the thinning scissors can be replicated by handling the attachment 600.

In one embodiment, the gap between adjacent teeth 625 of comb portion 620 of attachment 600 is 0.8 mm to 1.5 mm and the width of the tip of teeth tip portion 650 is 6.6 mm to 11.5 mm. Such a configuration may provide, for example, an attachment with a cut ratio of 50%.

In one embodiment, the gap between adjacent teeth 625 of comb portion 620 of attachment 600 is 0.7 mm to 0.9 mm and the width of the tip of teeth tip portion 650 is 8.7 mm to 9.0 mm. Such a configuration may provide, for example, an attachment with a cut ratio of 26%.

In one embodiment, the gap between adjacent teeth 625 of comb portion 620 of attachment 600 is 0.8 mm, the gap between adjacent teeth 625 for a shallow teeth gap 641 is 1.0 mm, the gap between adjacent teeth 625 for a deep teeth gap is 0.8 mm, and the width of the tip of teeth tip portion 650 is 8.8 mm. Such a configuration may provide, for example, an attachment with a cut ratio of 36%.

In one embodiment, of the spaces between adjacent teeth 625 of the comb portion 620 of the attachment 600, the gap between the teeth 625 having a shape with shallow depth is 0.8 to 1.0 mm and the gap between the teeth 625 having a shape with deep depth is 1.2 to 2.0 mm, and the height of the ear at the tip of the teeth tip portion 650 is 8.8 to 11.5 mm. Such a configuration may provide, for example, an attachment with a cut ratio of more than 67%.

The embodiments of the present invention are presented by way of example only, and are not intended to limit the scope of the invention. The novel embodiments described herein may be embodied in a variety of other forms: furthermore, various omissions, substitutions and changes may be made without departing from the spirit of the invention. These embodiments and variations thereof are included in the scope and spirit of the invention, as well as in the scope of the invention and its equivalents described in the claims.

### REFERENCE SIGNS LIST

100 . . . Vacuum-drawn electric hair clipper
110 . . . Top housing (first housing)
110a . . . End portion of top housing
120 . . . Middle housing
130 . . . Bottom housing (second housing)
140 . . . Clipper blade unit
140a . . . Blade portion
150 . . . Space
160 . . . Suction passage
170 . . . Connection opening
180 . . . Power supply terminals
190 . . . Inclined portion
195 . . . Power switch
200 . . . Suction hose
210 . . . Hose cover
220 . . . Power supply cord
230 . . . Power supply connector
250 . . . Inlet opening
260 . . . Lens cover
270 . . . LED cover
280 . . . Eccentric shaft
290 . . . Leaf spring
300 . . . Inclined surface
400 . . . Motor
410 . . . First buffer member (made of rubber)
420 . . . Second buffer member (made of rubber)
430 . . . Ball bearing
440 . . . Circuit board
450 . . . Sponge tape
460 . . . LED lighting unit
470 . . . LED
480 . . . LED board
490 . . . Screw
500 . . . Power connector (first connector)
510, 530 . . . Wire
520 . . . Motor connector (2nd connector)
540 . . . LED connector (3rd connector)
550 . . . First hose connection cover
560 . . . Second hose connection cover
580 . . . Plunger
600 . . . Attachment
610 . . . Attachment body portion
620 . . . Comb portion
625 . . . A plurality of teeth
625a, 625b, 625c, 625d . . . Teeth
630 . . . Mounting portion
640 . . . Inclined portion
641 . . . Shallow teeth gap
642 . . . Deep teeth gap
650 . . . Teeth tip portion

1.-8. (canceled)

9. An attachment for a vacuum-drawn electric hair clipper that is attachable to the vacuum-drawn electric hair clipper, that cuts hair suctioned into a space of a suction port formed between a blade portion of a clipper blade unit attached to one end of a bottom housing of a clipper main body and one end of a top housing of the clipper main body, by the blade portion, and that suctions the cut hair into a suction passage formed between a middle housing disposed between the top housing and the bottom housing and the top housing comprising:
a pair of mounting portions slidingly inserted while holding both sides of the clipper blade unit;
an attachment body forming a U-shaped recess with the pair of mounting portions; and
a plurality of teeth arranged between the pair of mounting portions,
wherein, when the attachment is attached to the clipper blade unit, the attachment has spaces between adjacent teeth of the plurality of teeth that face the clipper blade unit and spaces between adjacent teeth of the plurality of teeth that do not face the clipper blade unit.

10. The attachment for a vacuum-drawn electric hair clipper according to claim 9, wherein the spaces between the adjacent teeth that face the clipper blade unit and the spaces between adjacent teeth that do not face the clipper blade unit are such that one shallow teeth gap and one deep teeth gap are alternately arranged, and gaps of the shallow teeth gaps are narrower than gaps of the deep teeth gaps.

11. The attachment for a vacuum-drawn electric hair clipper according to claim 10, wherein the gaps of the shallow teeth gaps are 0.8 mm to 1.0 mm, and the gaps of the deep teeth gaps are 1.2 mm to 2.0 mm.

12. The attachment for a vacuum-drawn electric hair clipper according to claim 9, wherein a width of tips of the plurality of teeth is 8.8 mm to 11.5 mm.

13. The attachment for a vacuum-drawn electric hair clipper according to claim 9, wherein the spaces between the adjacent teeth that face the clipper blade unit and the spaces between adjacent teeth that do not face the clipper blade unit are such that one shallow teeth gap and one deep teeth gap are alternately arranged, and gaps of the shallow teeth gaps are identical to gaps of the deep teeth gaps.

14. The attachment for a vacuum-drawn electric hair clipper according to claim 13, wherein a portion of the deep teeth gaps face the blade portion and the shallow teeth gaps do not face the blade portion.

15. The attachment for a vacuum-drawn electric hair clipper according to claim 10, wherein a portion of the deep teeth gaps face the blade portion and the shallow teeth gaps do not face the blade portion.

16. A vacuum-drawn electric hair clipper comprising:
an electric hair clipper, that cuts hair suctioned into a space of a suction port formed between a blade portion of a clipper blade unit attached to one end of a bottom housing of a clipper main body and one end of a top housing of the clipper main body, by the blade portion, and that suctions the cut hair into a suction passage formed between a middle housing disposed between the top housing and the bottom housing and the top housing; and
an attachment attached to the clipper blade unit of the electric hair clipper,
wherein the attachment comprises:
a pair of mounting portions slidingly inserted while holding both sides of the clipper blade unit;
an attachment body forming a U-shaped recess with the pair of mounting portions; and
a plurality of teeth arranged between the pair of mounting portions, and
wherein, when the attachment is attached to the clipper blade unit, the attachment has spaces between adjacent teeth of the plurality of teeth that face the clipper blade unit and spaces between adjacent teeth of the plurality of teeth that do not face the clipper blade unit.

17. The vacuum-drawn electric hair clipper according to claim 16, wherein the spaces between the adjacent teeth that face the clipper blade unit and the spaces between adjacent teeth that do not face the clipper blade unit are such that one shallow teeth gap and one deep teeth gap are alternately arranged, and gaps of the shallow teeth gaps are identical to gaps of the deep teeth gaps.

18. The vacuum-drawn electric hair clipper according to claim 16, wherein the spaces between the adjacent teeth that face the clipper blade unit and the spaces between adjacent teeth that do not face the clipper blade unit are such that one shallow teeth gap and one deep teeth gap are alternately arranged, and gaps of the shallow teeth gaps are narrower than gaps of the deep teeth gaps.

19. The vacuum-drawn electric hair clipper according to claim 18, wherein a portion of the deep teeth gaps face the blade portion and the shallow teeth gaps do not face the blade portion.

20. The vacuum-drawn electric hair clipper according to claim 17, wherein a portion of the deep teeth gaps face the blade portion and the shallow teeth gaps do not face the blade portion.

21. The vacuum-drawn electric hair clipper according to claim 20, wherein hair caught in the deep teeth gaps has a high probability of being suctioned into the space of the suction port and being cut by the blade portion, and hair caught in the shallow teeth gaps has a low probability of being suctioned into the space of the suction port and not being cut by the blade portion.

22. The vacuum-drawn electric hair clipper according to claim 19, wherein hair caught in the deep teeth gaps has a high probability of being suctioned into the space of the suction port and being cut by the blade portion, and hair caught in the shallow teeth gaps has a low probability of being suctioned into the space of the suction port and not being cut by the blade portion.
